(19) United States
(12) Patent Application Publication
(10) Pub. No.: US 2001/0025263 A1
(43) Pub. Date: Sep. 27, 2001

(54) Multiple level philanthropic giving system and method

(76) Inventors: Victor L. Dorff, Agoura Hills, CA (US); Telma Elizabeth Sonne, Agoura Hills, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/749,373

(22) Filed: Dec. 22, 2000

Related U.S. Application Data
(60) Provisional application No. 60/171,450, filed on Dec. 22, 1999.

(51) Int. Cl. G06F 17/60

(52) U.S. Cl. 705/35

(57) ABSTRACT

A multiple level gift-giving system and method in which a negotiable philanthropy check is issued by a qualified charity to a consumer. The name of the payee is blank on the check. The name of any qualified charity is filled out either by the consumer or another who has received the philanthropy check as a gift or sale or other form of distribution. A comparison is made between the identity of the payee and a list of qualified charitable institutions and the check is honored if the payee is confirmed to be a qualified charitable institution but is not honored if the payee is not confirmed to be a qualified charitable institution.

### PRIORITY CLAIM

This application claims the benefit of U.S. Provisional Application Ser. No. 60/171,450 filed Dec. 22, 1999.

### FIELD OF THE INVENTION

This invention relates to systems and methods for enabling and promoting charitable giving and particularly multiple level charitable giving.

### SUMMARY OF THE INVENTION

Over 150 years ago, Alexis Tocqueville in his classic Democracy in America noted America's support of organized philanthropies. Today, we have hundreds of thousands of qualified tax exempt organizations and America's interest in organized charities remains a significant and notable aspect of our culture. Employee deduction plans and employee matching plans are, of course, common today. However, other than these, the manner and means of actually contributing moneys to these organizations has not changed a great deal over this 150 year period of time.

The preferred embodiments of this invention provide a novel system and method for managing, promoting, teaching, and enabling multiple levels of giving to philanthropies. A novel philanthropy “check” having a face value of a given dollar amount is given in return for a contribution of this amount plus service fee to a qualified charity. The contributor may directly contribute the face value of the check by filling in as payee the name of a qualified organization, or, the contributor may use the philanthropy check to promote multilevel giving. Rather than contributing the money directly to the qualified charity, the contributor can, for example, give the philanthropy check to anyone, for example, to an employee, to his or her child, or to another relative. Or, the contributor may choose to give philanthropy checks to a school, which in turn, gives the philanthropy checks to a class of students.

As a result, a single philanthropy check in accordance with the system and methods of this invention promotes multiple levels of giving with each level of participants receiving the pleasurable experience of charitable giving.

In this manner, multiple levels of entities and individuals gain the satisfaction and experience of giving. For example, an individual or company purchases 50 philanthropy checks, each having a face value of $50 and these checks are given to an elementary grade class of students as a class experience. Each student not only is taught the virtues and importance of supporting philanthropic organizations but given the hands-on experience of personally selecting a particular philanthropic organization, filling out the name of the philanthropic organization, and then mailing or otherwise delivering the philanthropy check to the organization.

The philanthropy check also offers an opportunity for a company to give a unique form of bonus to its employees by giving each employee a philanthropy check to give in turn to his or her favorite charity or to, in turn, give the check to a relative or friend who then fills out the payee portion of the check to his or her selected charity.

Another form of corporate giving is to match a portion of the face value of the philanthropy check. In one example, the employer issues a $100 philanthropy check upon receipt of only $30 from the employee with the corporation contributing the balance. In another example, the corporation offers the checks at face value and contributes the service fees.

In still another example, the employer, while not itself making a cash payment, facilitates and encourages its employees to contribute by buying and selling the philanthropy checks to its employees via a salary withholding plan.

These employer/employee uses of philanthropy checks thus promote giving at multiple levels. Another feature of these plans is that they have the attributes of (a) lowering the accounting, bookkeeping and other expenses incurred by a conventional matching fund program, (b) divorcing the employer from the charity selection process, and (c) makeing the program far more interesting to the employee because each employee has hundreds of thousands of charitable institutions to select from.

Other forms of distributing the philanthropy checks include point of services sales of the checks at businesses, awarding the philanthropy checks as sales incentives, awarding the philanthropy checks for frequent flyer miles, and marketing the philanthropy checks over the Internet. Whatever form of distribution is used, the philanthropy check maintains its character of encouraging individuals to make a unique gift that enables the ultimate donor to personally select a favorite charity of his or her choice.

### BRIEF DESCRIPTION OF THE DRAWINGS

FIG. 1 is composed of FIGS. 1A and 1B, the figures illustrating the multiple giving levels promoted and enabled by the preferred embodiments of the invention.

FIG. 2 illustrates the front side of a typical philanthropy check used in the systems and methods of this invention;

FIG. 3 illustrates the reverse side of the philanthropy check of FIG. 2;

FIG. 4 is a flow chart illustrating a preferred embodiment of a system and method of this invention; and

FIG. 5 is a detailed flow chart illustrating the handling of the philanthropy checks between the issuing charity and its bank

### DETAILED DESCRIPTION OF THE PREFERRED EMBODIMENT

The preferred embodiments of this invention enable a novel system and method for enhancing and facilitating the giving of money to organized charities. A feature of the invention is that philanthropic giving is encouraged and enhanced on at least two levels of giving.

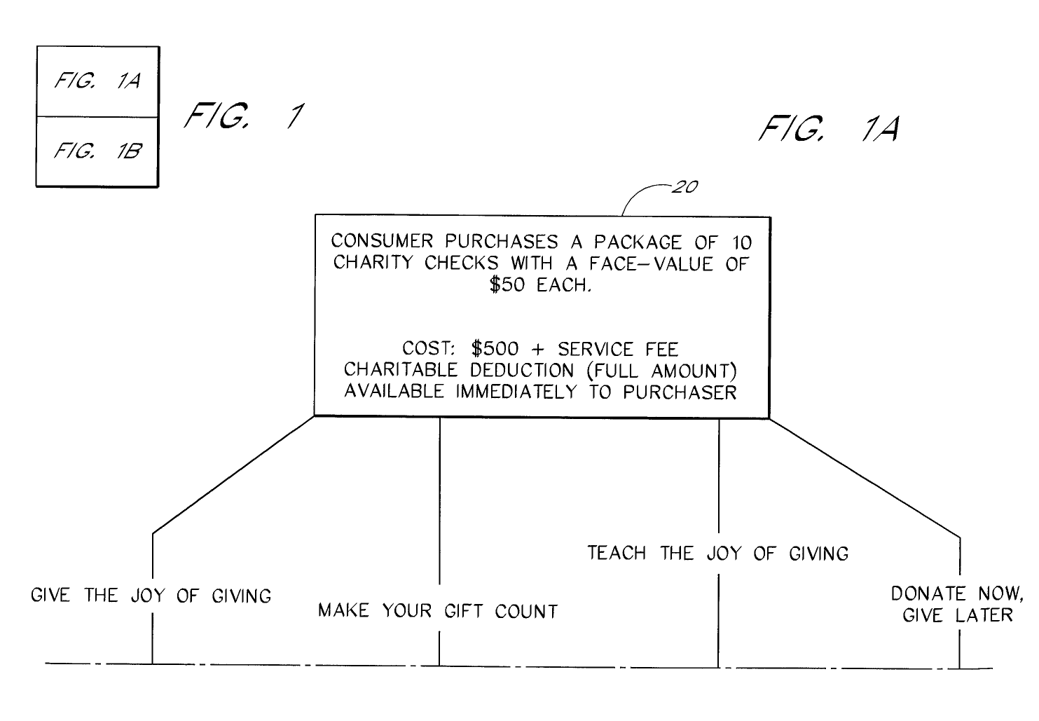

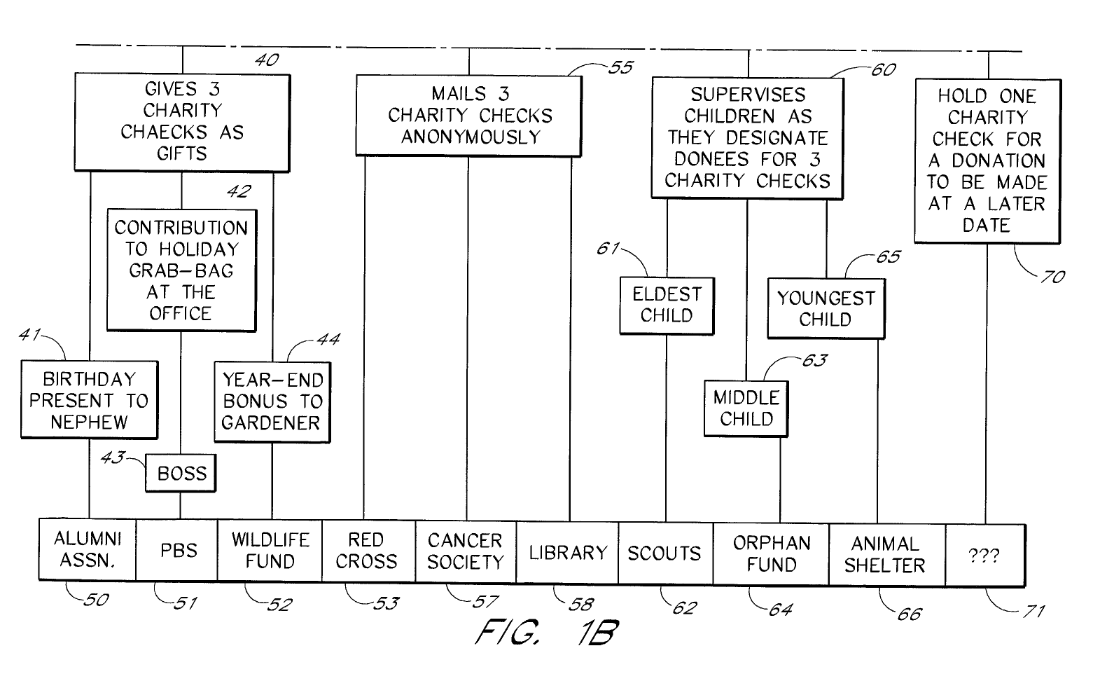

FIG. 1 is illustrative of the multilevel charitable giving provided by the invention. In the example shown, a consumer 20 purchases a package of 10 philanthropy checks denoted as “Charity Checks.” In the example shown, the consumer is an individual. However, as described in detail below, the invention is applicable to and useful by corporations, partnerships and business and institutions in general.

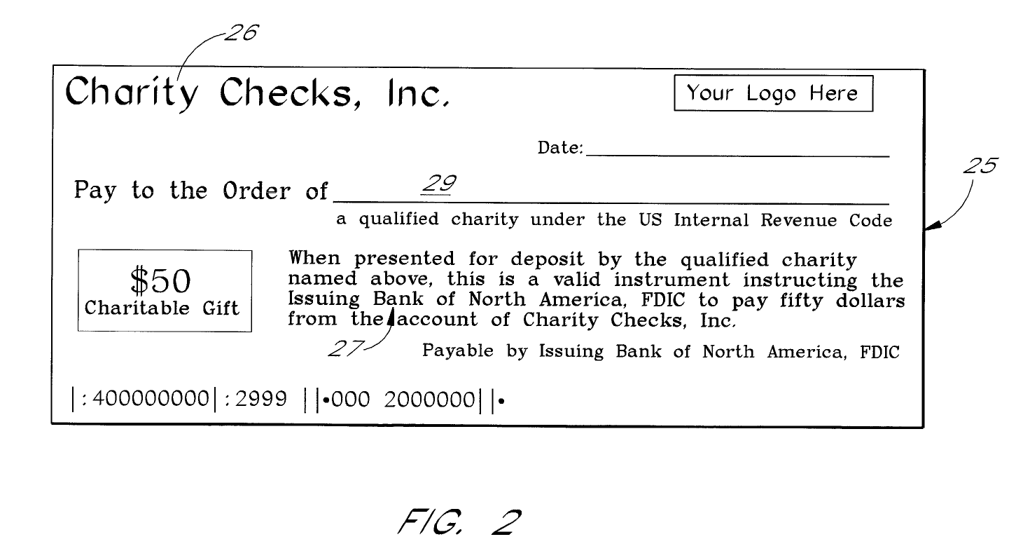

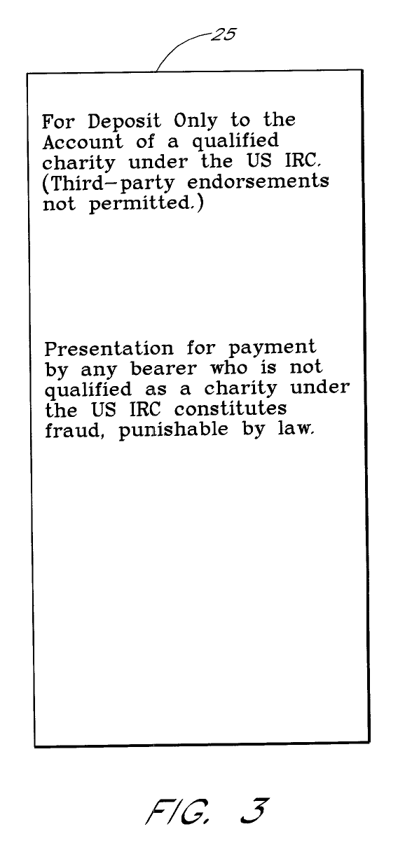

A replica of a typical philanthropy check 25 is illustrated in FIGS. 2 and 3. The front face of the check 25 conforms to a bankable negotiable instrument in which a payor 26 “Charity Check, Inc.” orders a drawee 27 “Bank of North America” to pay $50 to the payee identified in line 29. The rear face of the check shown in FIG. 3 includes a specific warning that check must not be presented by any entity that is not a qualified charity under the U.S. Internal Revenue Code (IRC). It will be understood that the specific identity of the payor 26 and drawee 27 will be determined in accordance with actual entities authorized to provide the systems and methods of this invention.

In addition, the face of the philanthropy check front may also include an additional notice to this effect that the transfer of the checks to a qualifying charity is not a charitable contribution. As noted below, the tax benefits are received when the consumer 20 initially contributes the face amount of the philanthropy check plus handling fee to the payor 26.

In one embodiment of the invention, the consumer's name or logo is imprinted on the philanthropy check 25. This would be particularly appropriate for a corporate donor. In another embodiment, the identity of the contributor is not indicated. This type of philanthropy check facilitates anonymous gifts.

It will be apparent that the check 25 may be issued in any convenient dollar denomination amount or other currency when used outside of the United States.

The consumer or purchaser 20 of the check 25 will pay the face value of each check plus a service fee to the authorized qualified charitable entity 26 shown in the example as Charity Checks, Inc. Thus, in the example shown in FIG. 1, the consumer will pay a total of $500 plus service fee for the 10 philanthropy checks. At this stage, by donating $500 plus fee to the Charity Checks, Inc. a charitable institute, the consumer 20 has performed a first level of charitable giving by making a charitable tax deductible contribution to the payor 26.

The second level of charitable giving is shown at block 40 in FIG. 1B. When the consumer 20 distributes three of the philanthropy checks 25 as gifts to others, shown by way of example, as a birthday present to a nephew (block 41), a contribution to a holiday grab bag at the office (block 42) and won by the boss (block 43) and a year-end bonus to the consumer's gardener (block 44).

A third level of giving occurs as shown in FIG. 1B when the nephew, the boss, and the gardener fill in the payee line 29 with the name of a particular qualified charity and send the check to such charity. Thus, in the example shown, the nephew contributes his $50 check to the Alumni Association (block 50), the boss contributes his $50 to the Public Broadcasting System PBS (block 51) and the gardener contributes his $50 check to the Wildlife Fund (block 52).

Another feature of the invention is that it facilitates anonymous giving since the identity of the actual contributor is not shown unless he or she makes known his or her identity. As illustrated in block 55 of FIG. 3, the consumer 20 makes three $50 anonymous gifts by mailing a $50 check to the Red Cross (block 56), the Cancer Society (block 57) and the library (block 58).

Another significant feature and advantage of the invention is that it enables children to have a very meaningful introduction and hands-on experience in charitable giving. Thus, in block 60 of FIG. 1B, the consumer 20 has given a $50 check to each of his or her children. Each child can then select which particular charity they wish to give to. Thus, as shown, the eldest child 61 donates his check to the Boy Scouts (block 62) by filling out the payee line 29 with the Boy Scouts and transmitting the check to the Boy Scouts. The middle child donates her check to the Orphan Fund (block 14) and the youngest child 65 donates her check to the Animal Shelter (block 66).

A feature of the preferred embodiments of the system and method of this invention is that the payor 26 itself is a qualified charity. As a result, the consumer 20 makes a charitable tax deduction contribution when the checks 20 are initially purchased. Thereafter, the person can, as shown by block 70 of FIG. 1B, hold on to the check to make a second level donation to a particular qualified charity (block 71) at a later date. In the meantime, the payor 26 can deposit the funds received and earn interest thereon with the money being used to promote the growth of charitable giving using the system and methods of this invention.

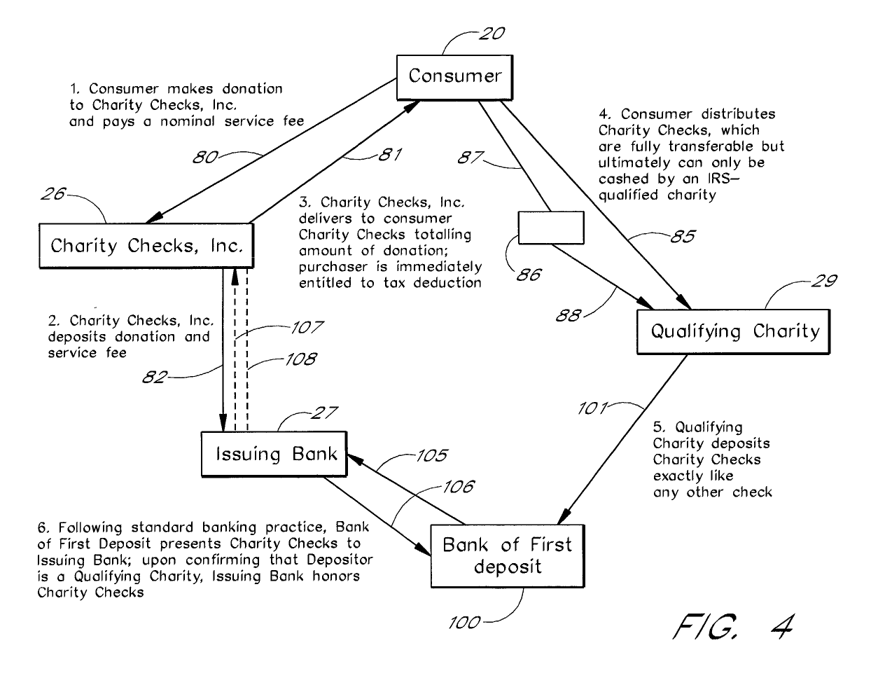

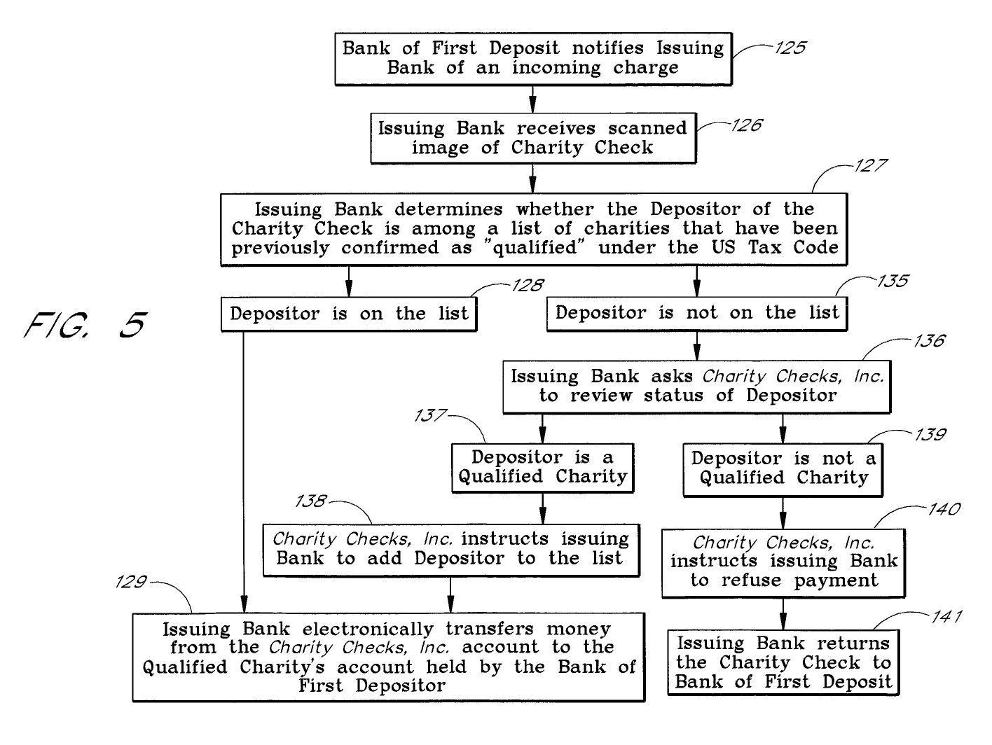

The system and method of a preferred embodiment of the invention providing the multiple levels of giving are illustrated in FIGS. 4 and 5. As described above, consumer 20 makes a donation (arrow 80) to a philanthropic institution 26 such as Charity Checks, Inc. Checks 25 are then issued by the charitable institution 26 to the consumer 20 (arrow 81). The philanthropic institution 26 maintains an account at the drawee bank 27 and deposits (arrow 82) consumer's donation and service fee at this bank.

Consumer 20 then, as described above, distributes the individual philanthropy checks 25. The consumer 20 can personally give (arrow 85) the checks 25 to any qualified charity 29, either in person or anonymously as described above. In addition, as also described above, the consumer 20 can distribute philanthropy checks 25 to create multiple levels of charitable giving. Thus, in the example of FIG. 1, a second level of giving is accomplished when the consumer 20 gives a philanthropy check 25 to another person 86 (arrow 87) such as the nephew, gardener, or children examples of FIG. 1.

The third level of giving occurs when the recipient person 86 fills out the payee line of philanthropy check 25 with the name of a qualified charitable institution 29 and forwards the check to such institution (arrow 88). The recipient qualifying charity 29 deposits the philanthropy check 25 in its bank 100 (arrow 101) in the same manner as all of the checks it receives. Following standard procedures, the philanthropy checks are ultimately received by the drawee bank 27 from the charity receiver's bank 100.

After confirmation that this institution that deposits the check in bank 100 is a qualifying charity 29, the issuing drawee bank 27 honors the philanthropy checks 25 and the amount there of is credited to the qualifying charity 29 in the usual manner.

A preferred embodiment of the system and method for qualifying the philanthropy checks 25 is shown in the flow chart of FIG. 5.

In block 125, the bank of first deposit 100 upon receipt of a philanthropy check notifies the drawee bank 27 of an incoming charge. The drawee issuing bank 27 receives a scanned image of the philanthropy check 25 (shown by block 126 of FIG. 5 and arrow 105 of FIG. 4). The drawee bank 25 then ascertains whether or not the organization depositing the philanthropy check 25 in bank 100 is a qualified charity under the U.S. Tax Code (block 127). Two systems and methods of accomplishing this are shown. In one method, the drawee issuing bank 27 compares the identify of the payee institution to determine whether the check depositor is qualified. Since the list of best known charities, e.g., Red Cross, Salvation Army, American Heart Association, etc. is relatively short, bank 27 can efficiently confirm whether or not the identity of the depositor is on its list. If the depositor is on this list (block 127), then the drawee bank electronically transfers money equal to the face value of the philanthropy check 27 to the payee's bank 100 (block 129) of FIG. 5 and arrow 106 of FIG. 4. If the name of the institution that deposited the philanthropy check does not appear on the drawee list of qualifying charities (block 135), the drawee bank 27 notifies the payor philanthropic organization 26 to review the status of the depositor (block 136 in FIG. 5 and dotted arrow 107 of FIG. 4). The payor then reviews a complete list of qualified charities. If the depositor is a qualified charity (block 137), the payor 26 instructs the drawee issuer bank 29 to honor the check (block 138 of FIG. 6 and arrow 108 of FIG. 4). If, however, the payor philanthropic organization 26 determines that the depositing institution is not a qualified charity (block 139), the payor philanthropic organization 26 instructs the issuing drawee bank 27 to refuse payment and not honor the check 25 (block 140) and returns the improper philanthropy check 25 to the bank of first deposit 100 (block 141 of FIG. 5 and arrow 106 of FIG. 4).

In an alternate system and method, images of all of the incoming philanthropy checks 25 are initially screened by the payor who instructs the drawee bank 20 to not honor any check that is not deposited by a qualified charity. In another alternative system, all of the philanthropy checks 25 are screened by the drawee bank 27 itself to prevent the honoring of a check made out to a nonqualified charity.

The specific examples shown in FIG. 1 illustrate a typical use of a preferred embodiment of the invention by an individual for both his or hers personal giving and also encouraging and teaching others to give to charitable institutions. Another example is an employer in the role of consumer 20 in which the philanthropy checks are given out as bonuses to employees, in which all or part of each of the cost of a check is borne by the employer. Each employee is thus involved in making his or her personal contribution to a charity of their choice or the recipient, in turn, can give the check to a friend or relative to give to an organized charity, thus amplifying the effect of a single philanthropy check to multiple levels of gift giving. A significant feature of the preferred embodiment of the system and method exemplified by the employer/employee example is that the employer is not burdened with many of the administrative costs associated with matching funds or salary deduction plans. For example, the employer has no follow up steps to take to qualify or make payment to the recipient charity since this is all accomplished when the employee fills out the name of the payee charity and transmits the philanthropy check 25 to such charity.

In another very important example, the consumer 20 presents a plurality of philanthropy checks to an elementary school. During class time, the students are taught the importance that Americans have always placed in charitable giving and, as part of the class participation, each student is given one of its donated philanthropy checks 25 to fill out with the name of a qualified charity selected by the student. In this manner, even young children can personally experience the satisfaction of a meaningful giving.

A significant feature of the philanthropy check is that it can be distributed in a number of very different channels. Airlines can award them for frequent flyer miles. Stores can award them as discounts on purchases. Stores and restaurants can sell philanthropy checks imprinted with their business logo. Dot corn companies can offer them as discounts, incentives, or gifts to their good customers. In every case, the recipient of the philanthropy check experiences the satisfaction that comes from the act of giving when the person fills in the name of a particular qualified charity on the payee line 29 of the philanthropy check 25.

what is claimed is:

1. A method for managing, promoting, teaching and enabling multiple levels of charitable giving to philanthropic organizations comprising:
printing a philanthropy negotiable check having (a) a face value in U.S. dollars, (b) the name of a charitable institution as payor, (c) the name of said payor's bank as drawee, (d) a blank line to be filled in as payee, and (e) a notice on the reverse side that the check must not be presented for payment by any entity that is not a qualified charitable institution,
distributing said philanthropy check to contributors to said charitable institution,
distributing said philanthropy checks by said contributors to any third party recipient through one or more levels of gift giving,
entering by said third party recipient the name of any qualified charitable institutions as payee of said philanthropy check,
delivering said philanthropy check to said payee charitable institution,
depositing said philanthropy checks in a bank by said payee qualified charitable institution,
confirming that said payee is a qualified charitable institution; and
transferring funds from said payor institution bank to said recipient qualified charitable institution after the payee has been confirmed to be a qualified charitable institution.

2. A multiple level philanthropic giving system comprising:
a philanthropy check on which is printed (a) the name of a charitable institution as payor and (b) the name of said institution's bank as drawee, (c) a blank line to be filled in with the name of the payee, and (d) a notice on the reverse side of the check that the check must not be presented for payment by an entity that is not a qualified charity;
first means for comparing the name of the payee with an abbreviated list of qualified charities, and
second means for comparing the name of the payee with complete list of qualified charities if said first means fails to locate the name of the payee on said abbreviated list of qualified charities.

3. A method for enabling multiple levels of charitable giving to philanthropic organizations comprising:
issuing to consumers a negotiable philanthropy check having a fixed monetary value, the payor of said check being a charitable institution,
filling in by the consumer or by any recipient who receives the philanthropy check originally issued to said consumer, the name of a second charitable institution as drawee of said philanthropy check, and
comparing the identity of said drawee with a list of qualified charities before the philanthropy check is honored by the drawee of said philanthropy check.

4. A gift giving method for enabling multiple levels of giving to philanthropic organizations comprising:
issuing to consumers a negotiable philanthropy check having a fixed monetary value, the payor of said check being a charitable institution, and
filling in by the consumer or by any recipient who receives the philanthropy check originally issued to said consumer, the name of a second charitable institution as drawee of said philanthropy check.

5. The gift giving method of claim 4, including distributing said philanthropy checks as incentive awards.

6. The gift giving method of claim 4, including distributing said philanthropy checks to students as part of an educational instruction on the importance of charitable giving.

7. The gift giving method of claim 4, including distributing said philanthropy checks as point of sale items.

8. The gift giving method of claim 4, including distributing said philanthropy checks using the Internet.

9. A gift giving method for enabling multiple levels of charitable giving to philanthropic organizations comprising:
comparing the identity of the payee of a philanthropy check said drawee with a list of qualified charities before the philanthropy check is honored by the drawee of said philanthropy check and funds are withdrawn from the payor's bank account.

10. The gift giving method of claim 9, wherein said comparing is performed by both the payor and the drawee.

11. The gift giving method of claim 9, wherein said comparing is substantially performed by the payor.

12. The gift giving method of claim 9, wherein said comparing is substantially performed by the drawee.

13. A philanthropy check comprising a printed document having:
a face value in U.S. dollars;
the name of a qualified charity as payor;
the name of a drawee bank;
a blank line to be filled in as payee;
a notice on the back side of the check that the check must not be presented for payment by other than a qualified charitable institution; and
a notice on the front side of the check that the transfer of the check to a qualifying charity is not a charitable contribution.

14. A philanthropy check comprising a printed document having:
a face value in U.S. dollars;
the name of a qualified charity as payor;
the name of a drawee bank;
a blank line to be filled in as payee; and
a notice on the side of the check that the check must not be presented for payment by other than a qualified charitable institution.
